(19) United States
(12) Patent Application Publication
(10) Pub. No.: US 2025/0117445 A1
(43) Pub. Date: Apr. 10, 2025

(54) SYSTEMS AND METHODS FOR REDUCING COMPUTE IN DIGITAL RIGHTS MANAGEMENT PROTECTION

(71) Applicant: Capital One Services, LLC, McLean, VA (US)

(72) Inventors: Joshua EDWARDS, Philadelphia, PA (US); Tyler MAIMAN, Melville, NY (US); Ian KATZMAN, Herndon, VA (US); Shahalam BAIG, Rochester, NY (US); Jackson WESTWOOD, New York, NY (US); Shasanka BHANDARI, McLean, VA (US); Matthew HUNSBERGER, Hoboken, NJ (US)

(73) Assignee: Capital One Services, LLC, McLean, VA (US)

(21) Appl. No.: 18/905,166

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/10

(52) U.S. Cl. CPC G06F 21/10

(57) ABSTRACT

Described are systems and methods for reducing compute in digital rights management (“DRM”) protection, including generating, via an application server, first media associated with first sensitive information, wherein the first media is substantially transparent and the first sensitive information is associated with a first content element, modifying, via the application server, the first media such that the first media includes at least one DRM technology to generate first DRM-protected media, generating, via an application server, first media associated with first sensitive information, wherein the first media is substantially transparent and the first sensitive information is associated with a first content element, causing to output, via a graphical user interface (“GUI”), the first DRM-protected content element such that the first DRM-protected media is displayed.

### CROSS-REFERENCE TO RELATED APPLICATION(S)

This application claims the benefit of pending U.S. Provisional Patent Application No. 63/587,891, filed on Oct. 4, 2023, pending U.S. Provisional Patent Application No. 63/665,485, filed on Jun. 28, 2024, and pending U.S. Provisional Patent Application No. 63/683,063, filed on Aug. 14, 2024, all of which are incorporated herein by reference in their entireties.

### TECHNICAL FIELD

Various embodiments of this disclosure relate generally to reducing compute in digital rights management (“DRM”) protection and, more particularly, to systems and methods for reducing compute in DRM protection by generating DRM-protected media.

### BACKGROUND

Organizations such as banks and healthcare providers seek to protect sensitive or confidential information (e.g., personally identifiable information (“PII”), financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, when the target is a user who uses a display screen (also referred to herein as a “screen”) of a computing device to view an account number on a bank's website, a social engineer using another computing device may attempt to persuade the user to reveal the account number to the social engineer. More specifically, the social engineer may convince the user to (i) share the user's screen (displaying the account number) with the social engineer using a screen sharing or remote desktop application, or (ii) take a screenshot of the user's screen (displaying the account number) using a screenshotting application, and then transmit the screenshot to the social engineer.

To guard against such social engineering, the bank may employ digital rights management (DRM) technologies, which are technologies that limit the use of digital content. For example, the bank may cause the user's display screen to present one or more videos, where each of the one or more videos is protected using DRM technologies. However, where the dimensions (e.g., X pixels by Y pixels) of at least one of the videos is relatively large, or where the bank causes at least two of the videos to be presented concurrently on the user's display screen, more processing resources (e.g., on a remote server) may be needed to generate the video(s), more network bandwidth may be used to transmit the video(s) from the remote server to the user's computing device, and the more slowly the video(s) or bank's website may be loaded, rendered, or presented on the display screen.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for reducing compute in digital rights management (“DRM”) protection.

In one aspect, a method for reducing compute in digital rights management (“DRM”) protection is disclosed. The method includes generating, via an application server, first media associated with first sensitive information, wherein the first media is substantially transparent and the first sensitive information is associated with a first content element, modifying, via the application server, the first media such that the first media includes at least one DRM technology to generate first DRM-protected media, generating, via an application server, first media associated with first sensitive information, wherein the first media is substantially transparent and the first sensitive information is associated with a first content element, and causing to output, via a graphical user interface (“GUI”), the first DRM-protected content element such that the first DRM-protected media is displayed.

In another aspect, a system is disclosed. The system may include at least one memory storing instructions and at least one processor operatively connected to the memory, and configured to execute the instructions to perform operations for reducing compute in digital rights management (“DRM”) protection. The operations may include generating, via an application server, first media associated with first sensitive information, wherein the first media is substantially transparent and the first sensitive information is associated with a first content element, modifying, via the application server, the first media such that the first media includes at least one DRM technology to generate first DRM-protected media, generating, via the application server, a first DRM-protected content element, wherein the first DRM-protected content element includes the first DRM-protected media, and causing to output, via a graphical user interface (“GUI”), the first DRM-protected content element such that the first DRM-protected media is displayed.

In another aspect, a method for reducing compute in digital rights management (“DRM”) protection is disclosed. The method may include generating, via an application server, first media associated with first sensitive information, wherein: the first media is substantially transparent and is a single frame-looped video, and the first sensitive information is associated with a first content element, determining a first set of dimensions associated with the first content element, determining a second set of dimensions associated with the first media, modifying, via the application server, the first media based on the second set of dimensions and to include at least one DRM technology to generate first DRM-protected media, comparing the first set of dimensions and second set of dimensions to determine a third set of dimensions to be associated with the first DRM-protected media, generating, via the application server, a first DRM-protected content element based on the first DRM-protected media and the third set of dimensions, wherein the first DRM-protected content element includes the first DRM-protected media, and causing to output, via a graphical user interface (“GUI”), the first DRM-protected content element such that the first DRM-protected media is output.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for reducing compute in digital rights DRM protection, according to one or more embodiments.

FIGS. 2A-3 depict exemplary methods for reducing compute in digital rights DRM protection, according to one or more embodiments.

FIGS. 4A-4B depict exemplary graphical user interfaces or reducing compute in digital rights DRM protection, according to one or more embodiments.

FIG. 5 depicts a simplified functional block diagram of a computer, according to one or more embodiments.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if”' is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “user” or the like may refer to a person authorized to access an account, attempting to access an account, etc. As used herein, the term “social engineer” may be a person or entity who seeks to manipulate a target (e.g., a customer or employee of an organization) into divulging sensitive information that may be used for fraudulent purposes. That is, a social engineer is a person or entity who engages in social engineering.

The phrase “hypertext markup language,” “HTML,” or the like may refer to a standardized system for tagging text files to achieve font, color, graphic, or hyperlink effects on World Wide Web pages. As used herein, the term “pixel” may refer to the smallest element (or unit) of a display screen that can be programmed by (or manipulated through) software. In some embodiments, a pixel may include sub-pixels (e.g., a red sub-pixel, a green sub-pixel, and a blue sub-pixel) that emit light to create a color displayed on the display screen. In some aspects, the color may be included in, or represent, text data, image data, or video data presented on the display screen.

As used herein, the phrase “media content” may represent a browser, a website, a webpage, etc. As used herein, the phrase “content element” may represent text data, image data, audio data (e.g., a sequence of audio frames), or video data (e.g., a sequence of image frames). A content element may be included in HTML used to structure the website, such as a Document Object Model (“DOM”), Cascading Style Sheets (“CSS”), etc. In some aspects, the content element may include or represent sensitive or confidential information (e.g., that may be displayed on a webpage (or webpage(s), website(s), portal(s) or application(s), etc.). As used herein, the phrase “sensitive information” may include personally identifiable information (“PII”) (e.g., a name, an address, a phone number, a social security number, etc.), financial information (e.g., an account number, an account balance, debits, credits, etc.), medical information (e.g., test results, appointments, medications, etc.), business information (e.g., proprietary information, trade secrets, etc.), government information (e.g., classified or secret information), any information a user may wish to not be shared with a third party, etc.

As used herein, the phrase “digital extraction” may refer to any process of copying content (e.g., audio, video, text, image, etc.), such as ripping, screensharing, screenshotting, etc. As used herein, the term “screenshare” may refer to a real time or near real time electronic transmission of data displayed on a display screen of a user's computing device to one or more other computing devices. The term “screensharing” and the phrase “being screenshared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” may represent an image of data displayed on a display screen of a computing device, where the image may be captured or recorded. The term “screenshotting” and the phrase “being screenshotted” may refer to capturing or recording a screenshot. In some aspects, screenshotting may be performed using a screenshotting application (e.g., the Snipping Tool in Microsoft's Windows 11® or an application accessed using a Print Screen key of a keyboard or keypad).

When encrypting different elements of a website using DRM video technology, each element may be encrypted individually, and each video may be transmitted across the network. As the size of the video increases, this may have a significant impact on the network throughput and the load time of the site. To avoid this, a video may be created that is a single pixel and single frame. That video may be overlaid on top of sensitive elements of a website. The web browser may recalculate the video to scale it to the appropriate size. This may cause the entirety of the video to be a block of a solid color. In order to prevent this video from blocking display when not being shared, the video may have substantial transparency, e.g., at 99% or higher. By transmitting this video (and reusing this video), the network throughput & webpage loading impacts of providing DRM-protected sensitive elements on webpages may be substantially reduced. The basic steps may be: (1) Generate a one pixel/one frame video; (2) Encrypt the video via DRM protection; (3) Create the mostly transparent video element on the website on top of the sensitive element; and (4) Repeat previous step as needed for each sensitive element.

To summarize, creating a specific video representation of each element may require a video per element. Instead, a transparent overlay video element that is DRM protected and optimized for size (such as being a single pixel) may be created, and the front end may scale it to the appropriate size. When the screen is shared, the video may be blocked by the DRM software. This video may be pre-created and quickly included in the content of each website as it is loaded.

In an exemplary use case, aspects of the present disclosure may relate to systems and methods for protecting one or more content elements associated with a website via reducing compute in digital rights management (“DRM”) protection. For example, a system may comprise at least one memory storing instructions, and at least one processor operatively connected to the at least one memory and configured to execute the instructions to perform operations for reducing compute in DRM protection for protecting a content element. In some aspects, the content element may represent sensitive or confidential information. In some aspects, the content element may be associated with a first set of dimensions (e.g., A pixels by B pixels, or A pixels by A pixels).

The operations may include generating, using an application server, a video associated with the content element. In some embodiments, the video may have dimensions of 1 pixel by 1 pixel, for example. Further, the video may include a single frame or image, and may be transparent. The operations may further include modifying (or processing) the video so that video includes one or more DRM technologies. The modified video may also be referred to herein as the “DRM-protected media.” The operations may further include comparing the dimensions (e.g., 1 pixel by 1 pixel) of the DRM-protected media to the first set of dimensions associated with the content element. In some embodiments, the operations may include determining a second set of dimensions associated with the DRM-protected media based on the comparison, where one or more dimensions of the second set of dimensions may be greater than or equal to one or more dimensions of the first set of dimensions. The operations may further include outputting, using the browser module, the DRM-protected transparent video and the content element to a display screen (e.g., a graphical user interface (“GUI”)), where the DRM-protected media may have the second set of dimensions and may be overlaid on the content element.

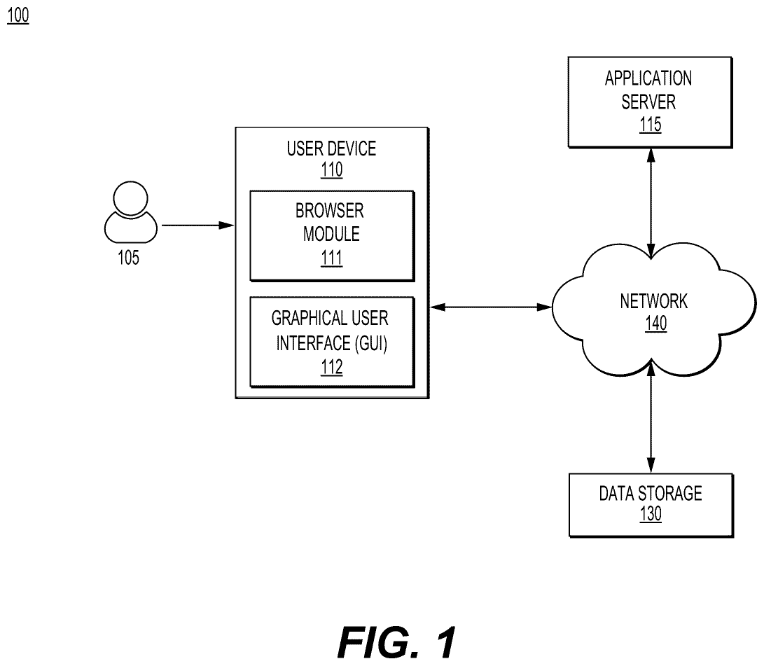

FIG. 1 depicts an exemplary environment 100 for reducing compute in DRM protection, according to one or more embodiments. In some aspects, the environment 100 may be an embodiment of (i) environment 100 described in U.S. Provisional Application 63/587,891, filed on Oct. 4, 2023, (ii) environment 100 described in U.S. Provisional Application 63/665,485, filed Jun. 28, 2024, or (iii) environment 100 described in U.S. Provisional Application 63/683,063, filed Aug. 14, 2024, where each of these U.S. provisional applications is incorporated by reference herein in its entirety. Environment 100 may include one or more aspects that may communicate with each other over a network 140, including, e.g., at least one memory storing instructions, and at least one processor operatively connected to the at least one memory and configured to execute the instructions to perform operations for reducing compute in DRM protection. In some embodiments, a user 105 may interact with a user device 110 such that media content (e.g., a website, a webpage, etc.) including at least one content element and associated sensitive information may be loaded. As depicted in FIG. 1, user device 110 may interact with at least one of an application server 115, a data storage 130, etc.

User device 110 may be configured to enable the user to access or interact with other systems in the environment 100. For example, user device 110 may be a computer system, e.g., a desktop computer, a laptop computer, a tablet, a smart cellular phone, a smart watch or other electronic wearable, etc. In some embodiments, user device 110 may include one or more electronic applications, e.g., a program, plugin, browser extension, etc., installed on a memory of user device 110. In some embodiments, the electronic applications may be associated with one or more of the other components (e.g., application server 115) in the environment 100.

User device 110 may include a browser module 111 or a graphical user interface (“GUI”) 112. Browser module 111 may be configured to analyze or transmit (e.g., to application server 115) one or more of an indication of digital extraction (e.g., screensharing, screenshotting, screen capture, etc.).

User device 110—or the one or more aspects of user device 110, e.g., browser module 111, GUI 112, etc.—may be configured to obtain data from one or more aspects of environment 100. For example, user device 110 may be configured to receive data from browser module 111, GUI 112 (e.g., via one or more inputs from user 105), application server 115, data storage 130, etc. User device 110 may be configured to transmit data to one or more aspects of environment 100, e.g., browser module 111, GUI 112, application server 115, data storage 130, etc.

Browser module 111 may be configured to detect an indication of media content, a content element, etc. loading. For example, user 105 may operate user device 110 to load media content. Browser module 111 may be configured to detect or receive an indication of the loading indication, request, etc. for media content to be loaded. In some embodiments, browser module 111 may be configured to detect or receive an indication of the loading indication, request, etc. for at least one content element (e.g., a first content element, a second content element, a third content element, etc.) associated with media content to be loaded.

Browser module 111 may be configured to detect an indication of digital extraction. In some embodiments, browser module 111 may be configured to receive the indication of digital extraction from other aspects of environment 100, such as user device 110.

Browser module 111 may be configured to receive data from other aspects of environment 100, such as user device 110, GUI 112, application server 115, data storage 130, etc. Browser module 111 may be configured to transmit the indication of digital extraction, e.g., to other aspects of environment 100, such as user device 110, GUI 112, application server 115, data storage 130, etc.

GUI 112 may be configured to cause to output media, DRM-protected media, etc. GUI 112 may be configured to output any number or any combination of media (e.g., first media, second media, third media, etc.), DRM-protected media (e.g., first DRM-protected media, second DRM-protected media, third DRM-protected media, etc.), etc.

GUI 112 may be configured to receive data (e.g., to cause to output, such as media, DRM-protected media, etc.) from other aspects of environment 100, such as user device 110, browser module 111, application server 115, data storage 130, etc. GUI 112 may be configured to transmit data (e.g., at least one user input) to other aspects of environment 100, such as to user device 110, browser module 111, application server 115, data storage 130, etc.

Application server 115 may be configured to generate media, e.g., media associated with sensitive information. The media may be a single frame-looped video. The media may be one (1) pixel by one (1) pixel. The media may be substantially transparent. For example, the media may be about 70%-80%, about 80%-90%, about 90%-99%, etc. transparent. It may be advantageous for the media to be less than 100% transparent because the DRM protection techniques may fail to completely render media that is 100% transparent, and therefore may fail to effectively block the 100% transparent media. In some embodiments, application server 115 maybe configured to generate media in response to the indication of media content, a content element, etc. loading, the indication of digital extraction, etc. For example, application server 115 may generate media in response to receiving at least one of the indication of media content, a content element, etc. loading or the indication of digital extraction (e.g., from browser module 111).

Application server 115 may be configured to modify media (e.g., first media, second media, third media, etc.) to generate DRM-protected media. For example, application server 115 may be configured to convert the media (e.g., a single frame-looped video) to DRM-protected media (e.g., a DRM-protected single frame-looped video). Converting the media to DRM-protected media may be configured to restrict the DRM-protected transparent video from being shared or recorded (or captured) by screen sharing application(s), remote desktop application(s), or screenshotting application(s), for example.

Application server 115 may be configured to generate a DRM-protected content element (e.g., a second content element) based on one or both of (1) the media or the DRM-protected media or (2) at least one set of dimensions. For example, application server 115 may be configured to generate the DRM-protected content element based on one of the media or the DRM-protected media using techniques described herein. For example, application server 115 may be configured to generate the DRM-protected content element based on a 1 (one) pixel by 1 (one) pixel, single frame-looped video, which may reduce compute required in utilizing the DRM technologies described herein. Typical DRM technologies may require a large amount of compute in generating multi-pixel, multi-frame videos, which may be more likely to malfunction due to the heightened compute requirement. Application server 115 may be configured to generate the DRM-protected content element as described in pending U.S. Provisional Patent Application No. 63/683,063, filed on Aug. 14, 2024, which is incorporated herein by reference in its entirety.

In another example, application server 115 may be configured to generate one or both of the media or the DRM-protected content element (e.g., the DRM-protected media of the DRM-protected content element) based on at least one set of dimensions. For example, application server 115 may be configured to generate first media that is one (1) pixel by one (1) pixel and may be stretched (e.g., via the HTML, JavaScript, CSS, etc.) to fit a set of dimensions (e.g., a first set of dimensions, a second set of dimensions, a third set of dimensions, etc.).

In some embodiments, application server 115 may be configured to determine a first set of dimensions associated with the first content element. For example, the first set of dimensions associated with the first content element may be the dimensions of the content element (e.g., an outermost border of the content element). Application server 115 may be configured to generate media (e.g., first media) based on the first set of dimensions associated with the first content element. Application server 115 may be configured to determine a second set of dimensions associated with the generated first media. For example, the second set of dimensions associated with the generated first media may be the actual dimensions of the first media. In some embodiments, application server 115 may be configured to generate first media such that the second set of dimensions (e.g., associated with the first media) exceeds the first set of dimensions (e.g., associated with the first content element). In some embodiments, application server 115 may be configured to generate first media such that the second set of dimensions (e.g., associated with the first media) is smaller than the first set of dimensions (e.g., associated with the first content element). In some embodiments, application server 115 may be configured to generate first media such that the second set of dimensions (e.g., associated with the first media) is substantially similar to the first set of dimensions (e.g., associated with the first content element).

In some embodiments, application server 115 may be configured to determine a third set of dimensions associated with the DRM-protected media. For example, the third set of dimensions associated with the DRM-protected media may be the difference in the dimensions of the first set of dimensions (associated with the first content element) and the second set of dimensions (associated with the generated first media). Application server 115 may be configured to determine the third set of dimensions by comparing the first set of dimensions and the second set of dimensions. For example, application server 115 may compare the first set of dimensions and the second set of dimensions and determine that the first set of dimensions exceeds the second set of dimensions (e.g., that the dimensions of the first content element exceeds the dimensions of the first media). In an embodiment where the second set of dimensions should exceed the first set of dimensions (e.g., where the dimensions of the first media should exceed the dimensions of the first content element), application server 115 may be configured to determine the third set of dimensions such that the third set of dimensions exceeds the first set of dimensions (e.g., such that the dimensions of the DRM-protected media exceed the dimensions of the first content element and the first media).

In another example, application server 115 may compare the first set of dimensions and the second set of dimensions and determine that the second set of dimensions exceeds the first set of dimensions (e.g., that the dimensions of the first media exceeds the dimensions of the first content element). In an embodiment where the second set of dimensions should exceed the first set of dimensions (e.g., where the dimensions of the first media should exceed the dimensions of the first content element), application server 115 may be configured to determine the third set of dimensions such that the third set of dimensions may be substantially equivalent to the second set of dimensions (e.g., such that the dimensions of the DRM-protected media are substantially equivalent to the dimensions of the first media). In a further embodiment where the second set of dimensions should exceed the first set of dimensions (e.g., where the dimensions of the first media should exceed the dimensions of the first content element), application server 115 may be configured to determine the third set of dimensions such that the third set of dimensions may exceed the second set of dimensions (e.g., such that the dimensions of the DRM-protected media exceed the dimensions of the first media).

Application server 115 maybe configured to obtain data from one or more aspects of environment 100. For example, application server 115 may be configured to receive data from user device 110, browser module 111, GUI 112, data storage 130, etc. Application server 115 may be configured to transmit data to one or more aspects of environment 100, e.g., to user device 110, browser module 111, GUI 112, data storage 130, etc.

Data storage 130 may be configured to cache media (e.g., first media, second media, etc.), DRM-protected media (e.g., first DRM-protected media, second DRM-protected media, etc.), etc. Data storage 130 may be configured to receive for caching, storing, retrieve from the storage, or transmit from the storage: media (e.g., first media, second media, etc.), DRM-protected media (e.g., first DRM-protected media, second DRM-protected media, etc.), sets of dimensions (e.g., the first set of dimensions, the second set of dimensions, the third set of dimensions, etc.), etc. Data storage 130 may be configured to receive data from other aspects of environment 100, such as from user device 110, browser module 111, GUI 112, application server 115, data storage 130, etc. Data storage 130 may be configured to transmit data to other aspects of environment 100, such as to user device 110, browser module 111, GUI 112, application server 115, data storage 130, etc.

One or more of the components in FIG. 1 may communicate with each other or other systems, e.g., across network 140. In some embodiments, network 140 may connect one or more components of environment 100 via a wired connection, e.g., a USB connection between user device 110 and data storage 130. In some embodiments, network 140 may connect one or more aspects of environment 100 via an electronic network connection, for example a wide area network (WAN), a local area network (LAN), personal area network (PAN), a content delivery network (CDN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, browser module 111 may be integrated in application server 115. In some embodiments, operations or aspects of one or more of the components discussed above may be distributed amongst one or more other components, e.g., one or both of browser module 111 or application server 115.

In some embodiments, some of the components of environment 100 may be associated with a common entity, while others may be associated with a disparate entity. For example, browser module 111 and application server 115 may be associated with a common entity (e.g., an entity with which user 105 has an account) while data storage 130 may be associated with a third party (e.g., a provider of data storage services). Any suitable arrangement or integration of the various systems and devices of the environment 100 may be used.

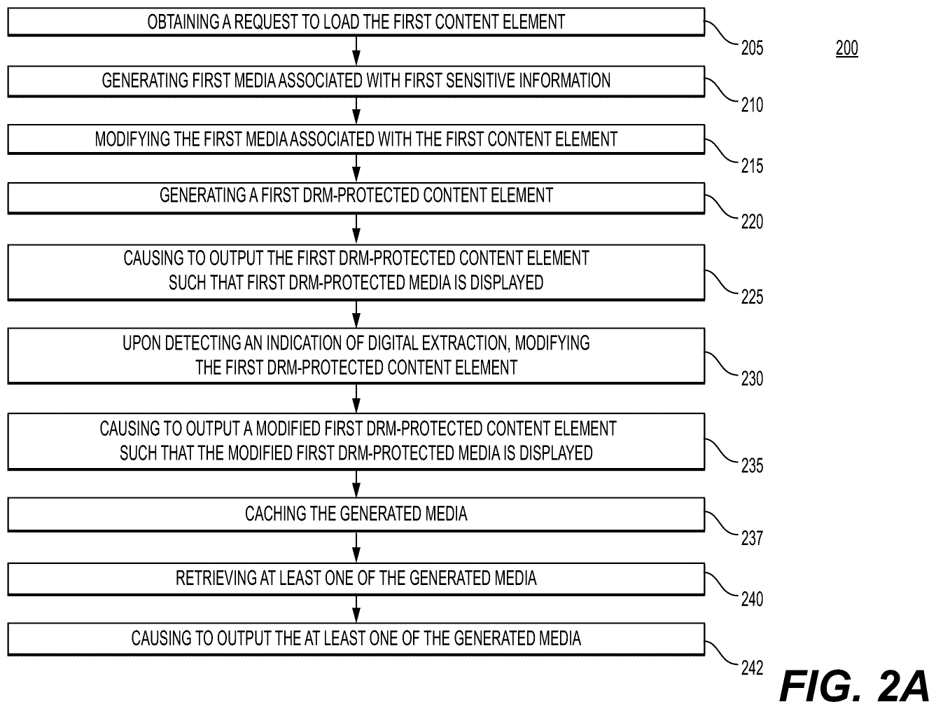

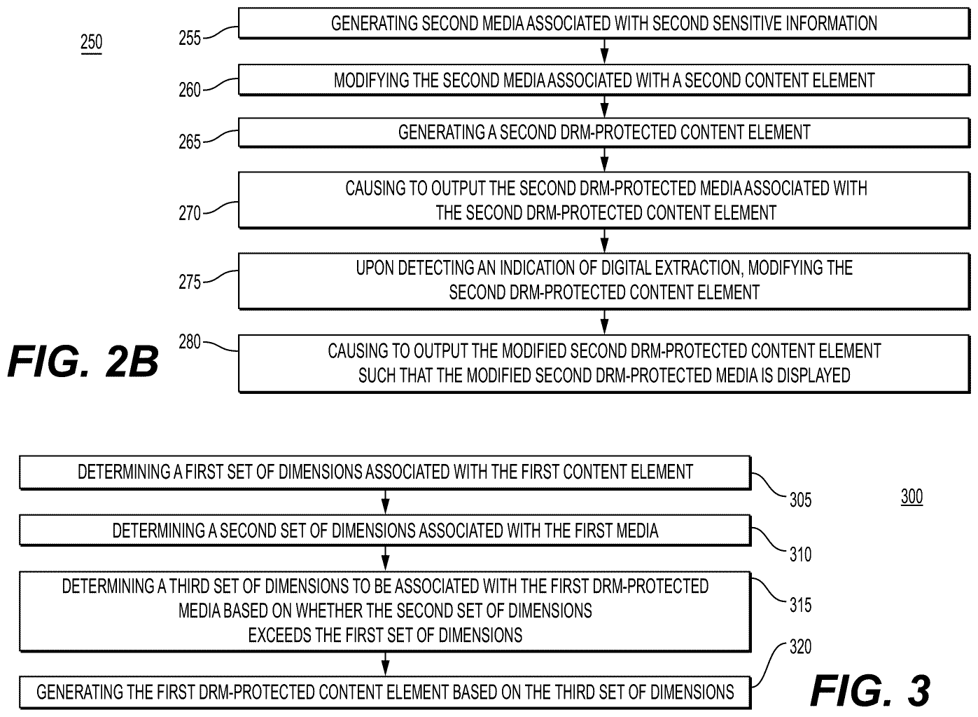

FIGS. 2A-2B depict exemplary methods for reducing compute in DRM protection, according to one or more embodiments. Aspects of the present disclosure relate to systems and methods for protecting one or more content elements (or data) displayed on a website (e.g., media content). For example, a system may comprise at least one memory storing instructions, and at least one processor operatively connected to the at least one memory and configured to execute the instructions to perform operations for reducing compute in protecting a content element via DRM protections. In some aspects, the content element may represent sensitive or confidential information. The content element may also be included in a first HyperText Markup Language (“HTML”) element used to structure the media content (e.g., a website, a webpage, etc.). In some aspects, the content element may be associated with a first set of dimensions (e.g., A pixels by B pixels, or A pixels by A pixels).

Method 200 of FIG. 2A depicts an exemplary method for reducing compute in DRM protection of a content element, according to one or more embodiments. At step 205, a request (or indication) to load a content element (e.g., a first HTML element) may be received (e.g., via browser module 111, application server 115, etc.). For example, user 105 may navigate to media content, which may initiate loading at least one content element (e.g., a first content element, a second content element, a third content element, etc.) of the media content. For example, a first content element (e.g., a content element without DRM protections) may be associated with a first HTML element. In another example, user 105 may navigate to media content, which may initiate transmission of an indication of the content element loading. One or both of the request to load the first content element or the indication of the first content element loading may be transmitted (e.g., to application server 115).

At step 210, first media associated with first sensitive information (e.g., first sensitive information contained or included with the first content element) may be generated (e.g., via application server 115). In some embodiments, the first sensitive information may be associated with the first content element. In some embodiments, the first media may be substantially transparent, a single frame-looped video (e.g., may include a single frame or image), one (1) pixel by one (1) pixel, etc. In some embodiments, the first media may be generated upon receiving the request to load the content element (e.g., the first content element). In some embodiments, the first media may be generated in response to receipt of a request to load (or display) the website (e.g., the media content, which may include the first content element) on a display screen of a computing device (e.g., via the application server or a browser module). In some embodiments, the first media may be generated based on a second set of dimensions, as discussed in further detail below (see discussion regarding FIG. 3). As discussed above, the second set of dimensions may be the actual dimensions of the first media, and the second set of dimensions may be determined based on a first set of dimensions associated with the first content element (e.g., the dimensions of the first content element).

At step 215, the first media may be modified (e.g., via application server 115). In some embodiments, the first media may be modified to include at least one DRM technology. The modified media may be referred to herein as “DRM-protected media” For example, if the first media is a single frame-looped video, the single frame-looped video may be modified to include DRM protections to generate first DRM-protected media. In some aspects, the DRM technologies may restrict the DRM-protected media from being shared or recorded (or captured) by digital extraction, such as via screen sharing application(s), remote desktop application(s), or screenshotting application(s).

At step 220, first DRM-protected content element (e.g., a second HTML element) may be generated (e.g., via application server 115). In some embodiments, the first DRM-protected content element may be generated based on the first content element and the first DRM-protected media. For example, the first content element may be modified to include the first DRM-protected media, thereby creating the first DRM-protected content element. In some embodiments, the first DRM-protected content element may be generated by replacing the first content element with a content element generated based on the first content element and the first DRM-protected media (e.g., a DRM-protected content element). For example, a content element may be generated to include the information (e.g., HTML, sensitive information, etc.) of the first content element and the first DRM-protected media to generate a first DRM-protected content element. In another example, the second HTML element of the first DRM-protected content element may replace the first HTML element of the first content element (e.g., via the DOM, CSS, etc.).

In some embodiments, the first media or the first DRM-protected content element may be generated based on at least one set of dimensions. Method 300 of FIG. 3 depicts an exemplary method for generating the first media or the first DRM-protected media, according to one or more embodiments. In some embodiments, both the first media and the first DRM-protected content element may be generated based on at least one set of dimensions. For example, the first media may be one (1) pixel by one (1) and may be stretched to match or exceed the dimensions of the content element. The stretched first media may then be overlaid on the content element.

At step 305, a first set of dimensions associated with the first content element may be determined. The first set of dimensions may be determined based on the HTML, a Document Object Model (“DOM”), etc. of the first content element.

At step 310, a second set of dimensions associated with the first media may be determined. For example, the first media may be one (1) pixel by one (1) pixel, but have various dimensions. In some embodiments, the second set of dimensions may be determined based on the first set of dimensions. For example, if the first set of dimensions is 200 pixels by 200 pixels, the second set of dimensions may be determined such that the second set of dimensions is equal to or exceeds the first set of dimensions (e.g., such that the second set of dimensions is equal to or exceeds 200 pixels by 200 pixels). In another example, if the first set of dimensions is 500 pixels by 200 pixels, the second set of dimensions may be determined such that the second set of dimensions is equal to or smaller than the first set of dimensions (e.g., such that the second set of dimensions is equal to or smaller than 500 pixels by 200 pixels). In other words, the second set of dimensions may be compared to the first set of dimensions to determine whether the first media may need to be stretched, shrunk, etc.

At step 315, a third set of dimensions to be associated with the DRM-protected media may be determined. As discussed herein, the third set of dimensions associated with the DRM-protected media may be the difference between the first set of dimensions (associated with the first content element) and the second set of dimensions (associated with the generated first media). In some embodiments, the third set of dimensions may be determined based on whether the second set of dimensions exceeds the first set of dimensions (e.g., at least one dimension is of greater magnitude than at least one other dimension). For example, if the second set of dimensions is 200 pixels by 200 pixels and the first set of dimensions is 200 pixels by 199 pixels, the third set of dimensions may be determined to exceed the first set of dimensions based on the pixel widths. In a further example, if the second set of dimensions is 200 pixels by 200 pixels (40,000 square pixels) and the first set of dimensions is 201 pixels by 199 pixels (39,999 square pixels), the third set of dimensions may be determined to exceed the first set of dimensions based on the total pixel area.

In some embodiments, the first set of dimensions and the second set of dimensions may be compared to determine whether the second set of dimensions exceeds the first set of dimensions. Based on the comparison, a third set of dimensions to be associated with the first DRM-protected media may be determined. For example, if the comparison determines the first set of dimensions (e.g., 200 pixels by 200 pixels) exceeds the second set of dimensions (e.g., 100 pixels by 100 pixels), the third set of dimensions may be determined such that the third set of dimensions is equal to or exceeds the first set of dimensions (e.g., 201 pixels by 201 pixels). In another example, if the comparison determines the second set of dimensions (e.g., 200 pixels by 200 pixels) exceeds the first set of dimensions (e.g., 100 pixels by 100 pixels), the third set of dimensions may be determined such that the third set of dimensions is equal to or exceeds the second set of dimensions (e.g., 200 pixels by 200 pixels).

At step 320, the first DRM-protected content element may be generated based on the third set of dimensions. In some embodiments, upon determining the first set of dimensions exceeds the second set of dimensions (e.g., via application server 115), the first DRM-protected content element may be generated. For example, if the third set of dimensions is equal to or exceeds the first set of dimensions, the first DRM-protected content element may be generated such that the first DRM-protected media is equal to or exceeds the first set of dimensions.

In some embodiments, upon determining the second set of dimensions exceeds the first set of dimensions (e.g., via application server 115), the first DRM-protected content element may be generated. For example, if the third set of dimensions is equal to or exceeds the second set of dimensions, the first DRM-protected content element may be generated such that the first DRM-protected media is equal to or exceeds the second set of dimensions. In other words, upon determining the first media may need to be stretched, shrunk, etc. (e.g., based on the comparison of the first set of dimensions and the second set of dimensions), the first media may be stretched, shrunk, etc. based on the third set of dimensions.

Returning to FIG. 2A, at step 225, the first DRM-protected content element may be caused to be output such that the first DRM-protected media is displayed (e.g., via GUI 112). In some embodiments, the first DRM-protected media may be caused to be output by being overlaid on the content element. In some embodiments, causing to output the first DRM-protected content element may include substituting the first HTML element (associated with the first content element) with the second HTML element (associated with the DRM-protected content element), as discussed in relation to step 220. Where the first HTML element is replaced with the second HTML element, the second HTML element-and the associated DRM-protected content element and the DRM-protected media-may be caused to be output (e.g., via GUI 112).

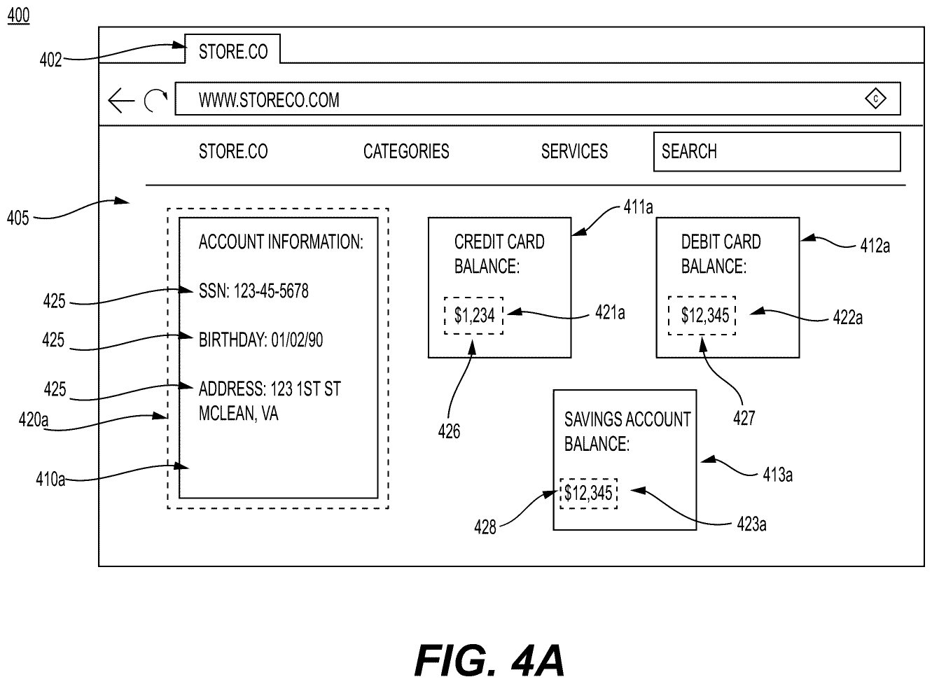

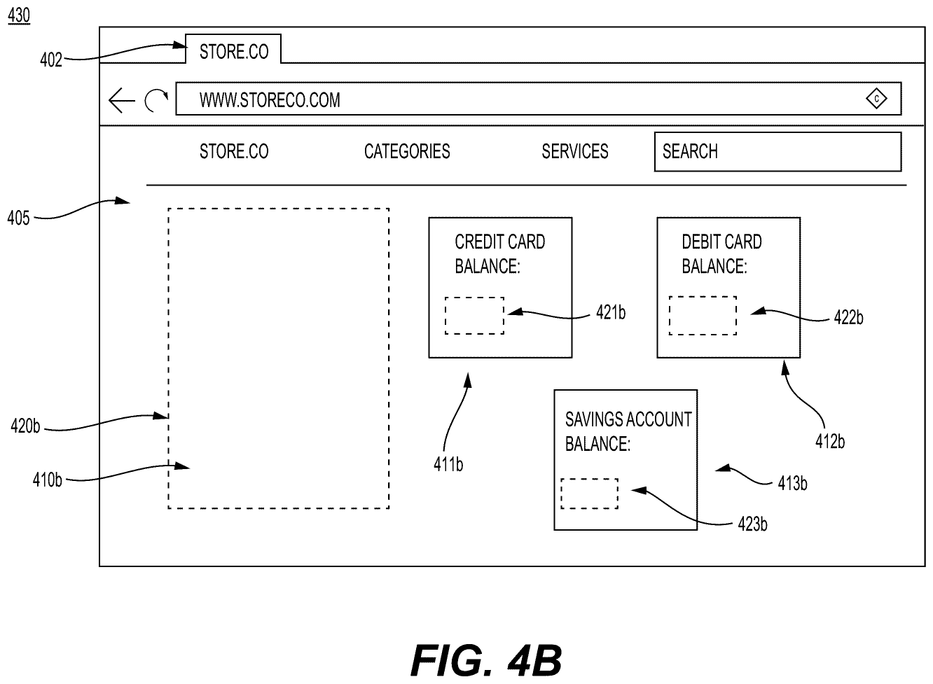

In some embodiments, where the display screen (e.g., GUI 112) is not being electronically shared or recorded (or captured) (e.g., there is no indication of digital extraction), the DRM-protected media may be displayed on the display screen (e.g., GUI 112) and appear transparent or substantially transparent. For example, as depicted in schematic 400 of FIG. 4A, website 402 may include a webpage 405 (e.g., media content). Webpage 405 may display at least one DRM-protected content element 410a, 411a, 412a, and 413a. The at least one DRM-protected content element 410a, 411a, 412a, and 413a may include sensitive information 425, 426, 427, and 428, respectively. A first DRM-protected content element 410a may be caused to be output (e.g., via GUI 112) such that a first DRM-protected media 420a may be caused to be displayed (e.g., via GUI 112). As depicted in FIG. 4A, first DRM-protected media 420a may be substantially transparent, such that sensitive information 425 may be visible (e.g., via GUI 112). As discussed herein, first DRM-protected media 420a may be a single frame-looped video.

In some embodiments, where an indication of digital extraction is detected (e.g., the display screen is being electronically shared or recorded), the first DRM-protected media 420a may be modified to protect the sensitive information (e.g., sensitive information 425). Indeed, returning to FIG. 2A, at step 230, the first DRM-protected content element (e.g., first DRM-protected content element 410a) may be modified upon detection (e.g., by browser module 111) or receipt (e.g., by browser module 111 or application server 115) of the indication of digital extraction. In some embodiments, the first DRM-protected media (e.g., first DRM-protected media 420a) may be modified to be opaque or substantially opaque, thereby modifying the first DRM-protected content element (e.g., first DRM-protected content element 410a) to generate a modified first DRM-protected content element (e.g., a modified first DRM-protected content element 410b, as discussed below).

At step 235, the modified first DRM-protected content element may be caused to be output such that the modified first DRM-protected media is displayed (e.g., via GUI 112). In some embodiments, the modified first DRM-protected media may be caused to be output by being overlaid on the content element. For example, as depicted in schematic 430 of FIG. 4B, modified first DRM-protected content element 410b may be caused to be output (e.g., via GUI 112) such that a modified first DRM-protected media 420b may be caused to be displayed (e.g., via GUI 112). As depicted in FIG. 4B, modified first DRM-protected media 420b may be substantially opaque, such that sensitive information 425 may not be visible (e.g., via GUI 112).

As discussed herein, modified first DRM-protected media 420b may be a single frame-looped video. In some embodiments, the DRM protections of modified first DRM-protected media 420b may cause the single frame-looped video to stop playing (or not play), and to appear as an opaque or substantially opaque image, which may conceal sensitive information 425. Accordingly, the modified first DRM-protected media (e.g., modified first DRM-protected media 420b) may protect the first content element (including the sensitive information associated with the first content element, e.g., sensitive information 425) from being shared with or captured by a social engineer.

In some embodiments, method 200 may be repeated for each of a plurality of content elements, e.g., to generate the at least one DRM-protected content element 410a, 411a, 412a, or 413a. Method 250 of FIG. 2B depicts an exemplary method for reducing compute in DRM protection of a second content element having second sensitive information, according to one or more embodiments.

At step 255, second media associated with second sensitive information may be generated (e.g., via application server 115). The second media may be generated using techniques described herein. In some embodiments, the second sensitive information may be associated with a second content element. In some embodiments, the second media may be substantially transparent, a single frame-looped video (e.g., may include a single frame or image), one (1) pixel by one (1) pixel, etc.

At step 260, the second media may be modified (e.g., via application server 115). In some embodiments, the second media may be modified to include at least one DRM technology according to the techniques described herein. For example, if the second media is a single frame-looped video, the single frame-looped video may be modified to include DRM protections to generate the second DRM-protected media.

At step 265, a second DRM-protected content element may be generated (e.g., via application server 115). In some embodiments, the second DRM-protected content element may be generated based on the second content element and the second DRM-protected media. For example, the second content element may be modified to include the second DRM-protected media, thereby creating the second DRM-protected content element. In some embodiments, the second DRM-protected content element may be generated by replacing the second content element with a content element generated based on the second content element and the second DRM-protected media. For example, a content element may be generated to include the information (e.g., HTML, sensitive information, etc.) of the second content element and the second DRM-protected media to generate a second DRM-protected content element.

At step 270, the second DRM-protected content element may be caused to be output such that the second DRM-protected media is displayed (e.g., via GUI 112). In some embodiments, the second DRM-protected media may be caused to be output by being overlaid on the second content element.

In some embodiments, where the display screen (e.g., GUI 112) is not being electronically shared or recorded (or captured) (e.g., there is no indication of digital extraction), the second DRM-protected media may be displayed on the display screen (e.g., GUI 112) and appear transparent or substantially transparent. For example, as depicted in FIG. 4A, a second DRM-protected content element 411a may be caused to be output (e.g., via GUI 112) such that a second DRM-protected media 421a may be caused to be displayed (e.g., via GUI 112). As depicted in FIG. 4A, second DRM-protected media 421a may be substantially transparent, such that sensitive information 426 contained in second DRM-protected content element 411a may be visible (e.g., via GUI 112). As discussed herein, second DRM-protected media 421a may be a single frame-looped video.

In some embodiments, where an indication of digital extraction is detected (e.g., the display screen is being electronically shared or recorded), the second DRM-protected media (e.g., second DRM-protected media 421a) may be modified to protect the sensitive information (e.g., sensitive information 426). Returning to FIG. 2B, at step 275, the second DRM-protected content element may be modified upon detection (e.g., by browser module 111) or receipt (e.g., by browser module 111 or application server 115) of the indication of digital extraction. In some embodiments, the second DRM-protected media (e.g., second DRM-protected media 421a) may be modified to be opaque or substantially opaque, thereby modifying the second DRM-protected content element (e.g., second DRM-protected content element 411a) to generate a modified second DRM-protected content element (e.g., a modified second DRM-protected content element 411b, as discussed below).

At step 280, the modified second DRM-protected content element may be caused to be output such that the modified second DRM-protected media is displayed (e.g., via GUI 112). In some embodiments, the modified second DRM-protected media may be caused to be output by being overlaid on the content element. For example, as depicted in FIG. 4B, a modified second DRM-protected content element 411b may be caused to be output (e.g., via GUI 112) such that a modified second DRM-protected media 421b may be caused to be displayed (e.g., via GUI 112). As depicted in FIG. 4B, modified second DRM-protected media 421b may be substantially opaque, such that sensitive information 426 may not be visible (e.g., via GUI 112).

As discussed herein, modified second DRM-protected media 421b may be a single frame-looped video. In some embodiments, the DRM protections of modified second DRM-protected media 421b may cause the single frame-looped video to stop playing (or not play), and to appear as an opaque or substantially opaque image, which may conceal sensitive information 425). Accordingly, the modified second DRM-protected media (e.g., modified second DRM-protected media 421b) may protect the second content element (including the sensitive information associated with the second content element, e.g., sensitive information 426) from being shared with or captured by a social engineer.

Because the media described herein (e.g., the first media, the first DRM-protected media, the modified first DRM-protected media, the second media, the second DRM-protected media, the modified second DRM-protected media, etc.) may be generated with relatively small dimensions (e.g., 1 pixel by 1 pixel), fewer processing resources (e.g., of a remote server) may be needed to generate the media. Additionally, less network bandwidth may be required to transmit the media from a server (e.g., from application server 115) to the computing device (e.g., user device 110) once the media has been DRM-protected. Further, the DRM-protected media, even when scaled (e.g., associated with a larger set of dimensions), may be loaded on the display screen (e.g., GUI 112) more quickly.

Moreover, in some embodiments, the media discussed herein may be cached. Returning to FIG. 2A, at step 237, the media generated by methods 200, 250, or 300 may be cached. For example, the generated media (e.g., the first media, the first DRM-protected media, the modified first DRM-protected media, the second media, the second DRM-protected media, the modified second DRM-protected media, etc.) may be cached when the media content (e.g., website 402) is not being displayed. In some embodiments, the generated media may be cached in a storage system (e.g., data storage 130).

When the media content (e.g., website 402) is subsequently displayed, the one or more DRM-protected media may be retrieved from the cache at step 240. In some embodiments, at least one of the first media, the first DRM-protected media, the modified first DRM-protected media, the second media, the second DRM-protected media, the modified second DRM-protected media, etc. may be retrieved. For example, if the indication of digital extraction is not detected, the first DRM-protected media and the second DRM-protected media may be retrieved. In another example, if the indication of digital extraction is detected, the modified first DRM-protected media and the modified second DRM-protected media may be retrieved. In some embodiments, the retrieved media may be scaled to dimensions sufficient to cover one or more respective content elements using the techniques described herein.

At step 242, at least one of the generated media retrieved (e.g., from data storage 130) may be caused to be output (e.g., via GUI 112). For example, if the first DRM-protected media and the second DRM-protected media are retrieved because the indication of digital extraction is not detected, at least one of the first DRM-protected media and the second DRM-protected media may be caused to be output (e.g., via GUI 112). In another example, if the modified first DRM-protected media and the modified second DRM-protected media are retrieved because the indication of digital extraction is detected, at least one of the modified first DRM-protected media and the modified second DRM-protected media may be caused to be output (e.g., via GUI 112).

The retrieved media may be overlaid on the one or more respective content elements on the display screen (e.g., via GUI 112), as discussed herein (see discussion of FIGS. 4A and 4B). Because the media, the DRM-protected media, or the modified DRM-protected media may be cached and reused (instead of being replaced by new media, DRM-protected media, or modified DRM-protected media), processing and network bandwidth resources may be conserved. In other words, a single media may be generated and retrieved for use in association with numerous content elements. For example, a media A may be generated, retrieved, or overlaid on a first content element, a second content element, a third content element, etc.

It should be noted that multiple content elements and DRM-protected media may be caused to be generated, modified, displayed, caused to be output, cached, etc. using the techniques described herein (e.g., in methods 200, 250, and 300). For example, as depicted in FIG. 4A, first DRM-protected content element 410a and associated first DRM-protected media 420a, second DRM-protected content element 411a and associated second DRM-protected media 421a, a third DRM-protected content element 412a and an associated third DRM-protected media 422a, and a fourth DRM-protected content element 413a and an associated fourth DRM-protected media 423a may be caused to be output (e.g., via GUI 112). For example, as discussed herein, first DRM-protected content element 410a and associated first DRM-protected media 420a may be caused to be output such that sensitive information 425 is visible (e.g., via GUI 112). In another example, as discussed above, second DRM-protected content element 411a and associated second DRM-protected media 421a may be caused to be output such that sensitive information 426 is visible (e.g., via GUI 112). In another example, third DRM-protected content element 412a and associated third DRM-protected media 422a may be caused to be output such that sensitive information 427 is visible (e.g., via GUI 112). In a further example, fourth DRM-protected content element 413a and associated fourth DRM-protected media 423a may be caused to be output such that sensitive information 428 is visible (e.g., via GUI 112). Each of first DRM-protected media 420a and associated first DRM-protected content element 410a, second DRM-protected media 421a and associated second DRM-protected content element 411a, third DRM-protected media 422a and associated third DRM-protected content element 412a, and fourth DRM-protected media 423a and associated fourth DRM-protected content element 413a may have been generated, modified, displayed, caused to be output, etc. using the techniques described herein.

In another example, as depicted in FIG. 4B, modified first DRM-protected media 420b, modified second DRM-protected media 421b, a modified third DRM-protected media 422b, and a modified fourth DRM-protected media 423b may be caused to be output (e.g., via GUI 112). For example, as discussed herein, modified first DRM-protected content element 410b and associated modified first DRM-protected media 420b may be caused to be output such that sensitive information 425 is not visible (e.g., via GUI 112). In another example, as discussed herein, modified second DRM-protected content element 411b and associated modified second DRM-protected media 421b may be caused to be output such that sensitive information 426 is not visible (e.g., via GUI 112). In another example, modified third DRM-protected content element 412b and associated modified third DRM-protected media 422b may be caused to be output such that sensitive information 427 is not visible (e.g., via GUI 112). In a further example, modified fourth DRM-protected content element 413b and associated modified fourth DRM-protected media 423b may be caused to be output such that sensitive information 428 is not visible (e.g., via GUI 112). Each of modified first DRM-protected media 420b and associated modified first DRM-protected content element 410b, modified second DRM-protected media 421b and associated modified second DRM-protected content element 411b, modified third DRM-protected media 422b and an associated modified third DRM-protected content element 412b, and modified fourth DRM-protected media 423b and associated modified fourth DRM-protected content element 413b may have been generated, modified, displayed, caused to be output, etc. using the techniques described herein.

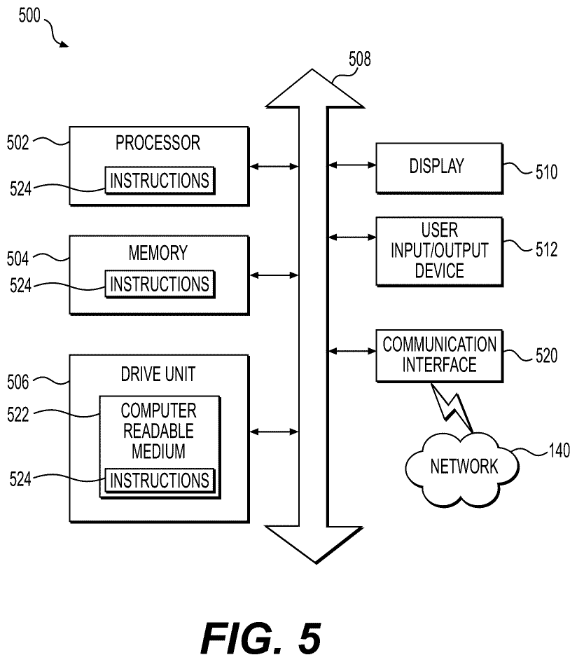

FIG. 5 depicts a simplified functional block diagram of a computer 500 that may be configured as a device for executing the methods disclosed here, according to exemplary embodiments of the present disclosure. For example, the computer 500 may be configured as a system according to exemplary embodiments of this disclosure. In various embodiments, any of the systems herein may be a computer 500 including, for example, a data communication interface 520 for packet data communication. The computer 500 also may include a central processing unit (CPU) 502, in the form of one or more processors, for executing program instructions. The computer 500 may include an internal communication bus 508, and a storage unit 506 (such as ROM, HDD, SDD, etc.) that may store data on a computer readable medium 522, although the computer 500 may receive programming and data via network communications. The computer 500 may also have a memory 504 (such as RAM) storing instructions 524 for executing techniques presented herein, although the instructions 524 may be stored temporarily or permanently within other modules of computer 500 (e.g., processor 502 or computer readable medium 522). The computer 500 also may include input and output ports 512 or a display 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention. The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for reducing compute in digital rights management (“DRM”) protection, the method comprising:
generating, via an application server, first media associated with first sensitive information, wherein the first media is substantially transparent and the first sensitive information is associated with a first content element;
modifying, via the application server, the first media such that the first media includes at least one DRM technology to generate first DRM-protected media;
generating, via an application server, first media associated with first sensitive information, wherein the first media is substantially transparent and the first sensitive information is associated with a first content element; and
causing to output, via a graphical user interface (“GUI”), the first DRM-protected content element such that the first DRM-protected media is displayed.

2. The method of claim 1, wherein the first media is a single frame-looped video.

3. The method of claim 1, wherein generating the first media associated with a first sensitive information further comprises:
determining a first set of dimensions associated with the first content element; and
generating the first media based on the first set of dimensions.

4. The method of claim 3, further comprising:
determining a second set of dimensions associated with the first media; and
comparing the first set of dimensions and second set of dimensions to determine a third set of dimensions to be associated with the first DRM-protected media.

5. The method of claim 4, further comprising:
determining whether the second set of dimensions exceeds the first set of dimensions; and
upon determining the second set of dimensions exceeds the first set of dimensions, generating the first DRM-protected content element based on at least the third set of dimensions via the application server.

6. The method of claim 1, further comprising:
upon detecting an indication of digital extraction, modifying the first DRM-protected content element such that the first DRM-protected media is modified to be substantially opaque; and
causing to output, via the GUI, the modified first DRM-protected content element such that the modified first DRM-protected media is displayed.

7. The method of claim 1, further comprising:
generating, via an application server, second media associated with second sensitive information, wherein the second media is substantially transparent and the second sensitive information is associated with a second content element;
modifying, via the application server, the second media such that the second media includes at least one DRM technology to generate second DRM-protected media;
generating, via the application server, a second DRM-protected content element, wherein the second DRM-protected content element includes the second DRM-protected media; and
causing to output, via the GUI, the second DRM-protected content element such that the second DRM-protected media is output.

8. The method of claim 7, further comprising:
causing to output, via the GUI, the first DRM-protected content element and the second DRM-protected content element such that both the first DRM-protected media and the second DRM-protected media are output.

9. The method of claim 7, further comprising:
caching, via a storage system, the first DRM-protected media and the second DRM-protected media;
upon receiving a request to load at least one of the first content element or the second content element, retrieving at least one of the first DRM-protected media or the second DRM-protected media; and
causing to output, via the GUI, the at least one of the first DRM-protected media or the second DRM-protected media.

10. The method of claim 1, further comprising:
receiving a request to load the first content element via a browser module; and
upon receiving the request, generating the first media associated with the first sensitive information.

11. A system, the system comprising:
at least one memory storing instructions; and
at least one processor operatively connected to the memory, and configured to execute the instructions to perform operations for reducing compute in digital rights management (“DRM”) protection, the operations including:
generating, via an application server, first media associated with first sensitive information, wherein the first media is substantially transparent and the first sensitive information is associated with a first content element;
modifying, via the application server, the first media such that the first media includes at least one DRM technology to generate first DRM-protected media;
generating, via the application server, a first DRM-protected content element, wherein the first DRM-protected content element includes the first DRM-protected media; and
causing to output, via a graphical user interface (“GUI”), the first DRM-protected content element such that the first DRM-protected media is displayed.

12. The system of claim 11, wherein generating the first media associated with a first sensitive information further comprises:
determining a first set of dimensions associated with the first content element; and
generating the first media based on the first set of dimensions.

13. The system of claim 12, wherein the operations further include:
determining a second set of dimensions associated with the first media; and
comparing the first set of dimensions and second set of dimensions to determine a third set of dimensions to be associated with the first DRM-protected media.

14. The system of claim 13, wherein the operations further include:
determining whether the second set of dimensions exceeds the first set of dimensions; and
upon determining the second set of dimensions exceeds the first set of dimensions, generating the first DRM-protected content element based on at least the third set of dimensions via the application server.

15. The system of claim 11, wherein the operations further include:
upon detecting an indication of digital extraction, modifying the first DRM-protected content element such that the first DRM-protected media is modified to be substantially opaque; and
causing to output, via the GUI, the modified first DRM-protected content element such that the modified first DRM-protected media is displayed.

16. The system of claim 11, wherein the operations further include:
generating, via an application server, second media associated with second sensitive information, wherein the second media is substantially transparent and the second sensitive information is associated with a second content element;
modifying, via the application server, the second media such that the second media includes at least one DRM technology to generate second DRM-protected media;
generating, via the application server, a second DRM-protected content element, wherein the second DRM-protected content element includes the second DRM-protected media; and
causing to output, via the GUI, the second DRM-protected content element such that the second DRM-protected media is output.

17. The system of claim 16, wherein the operations further include:
causing to output, via the GUI, the first DRM-protected content element and the second DRM-protected content element such that both the first DRM-protected media and the second DRM-protected media are output.

18. The system of claim 16, wherein the operations further include:
caching, via a storage system, the first DRM-protected media and the second DRM-protected media;
upon receiving a request to load at least one of the first content element or the second content element, retrieving at least one of the first DRM-protected media or the second DRM-protected media; and
causing to output, via the GUI, the at least one of the first DRM-protected media or the second DRM-protected media.

19. The system of claim 11, wherein the operations further include:
receiving a request to load the first content element via a browser module; and
upon receiving the request, generating the first media associated with the first sensitive information.

20. A method for reducing compute in digital rights management (“DRM”) protection, the method comprising:
generating, via an application server, first media associated with first sensitive information, wherein:
the first media is substantially transparent and is a single frame-looped video, and
the first sensitive information is associated with a first content element;
determining a first set of dimensions associated with the first content element;
determining a second set of dimensions associated with the first media;
modifying, via the application server, the first media based on the second set of dimensions and to include at least one DRM technology to generate first DRM-protected media;
comparing the first set of dimensions and second set of dimensions to determine a third set of dimensions to be associated with the first DRM-protected media;
generating, via the application server, a first DRM-protected content element based on the first DRM-protected media and the third set of dimensions, wherein the first DRM-protected content element includes the first DRM-protected media; and
causing to output, via a graphical user interface (“GUI”), the first DRM-protected content element such that the first DRM-protected media is output.
